(19) United States
(12) Patent Application Publication
(10) Pub. No.: US 2026/0195238 A1
(43) Pub. Date: Jul. 9, 2026

(54) RENDERING CONTROL METHOD, ELECTRONIC DEVICE AND STORAGE MEDIUM

(71) Applicant: Beijing Zitiao Network Technology Co., Ltd., Beijing (CN)

(72) Inventor: Qili ZHOU, Beijing (CN)

(21) Appl. No.: 19/298,071

(22) Filed: Aug. 12, 2025

(30) Foreign Application Priority Data
Jan. 7, 2025 (CN) 202510026917.7

(51) Int. Cl. G06F 11/362

(52) U.S. Cl. CPC G06F 11/362

(57) ABSTRACT

The present disclosure provides a rendering control method and apparatus, an electronic device, a storage medium and a program product. The method includes: receiving an information acquisition instruction for a target program sent from a client by a preset rendering carrier; then performing data interaction with the client based on the preset rendering carrier, without switching back and forth; performing data information collection on the target program according to the information acquisition instruction; directly generating corresponding rendered data after collection; and directly sending the rendered data to the client to be displayed on the preset rendering carrier.

### CROSS-REFERENCE TO RELATED APPLICATION

This application claims the priority to and benefits of the Chinese Patent Application, No. 202510026917.7, which was filed on Jan. 7, 2025. The aforementioned patent application is hereby incorporated by reference in its entirety.

### TECHNICAL FIELD

The present disclosure relates to the technical field of data processing, and in particular, relates to a rendering control method and apparatus, an electronic device, a storage medium and a program product.

### BACKGROUND

In related technologies, in the process of unified rendering for some developed programs, it is necessary to render and display separately in a client and an operation terminal.

Consequently, the staff needs to frequently switch between the two parts to render the displayed data separately, which is more cumbersome.

### SUMMARY

In view of this, the purpose of the present disclosure is to propose a rendering control method, apparatus, electronic device, storage medium and program product to solve or partially solve the above-mentioned technical problems.

Based on the above purpose, the present disclosure provides a rendering control method, including: receiving an information acquisition instruction for a target program sent from a client by a preset rendering carrier; collecting data information of the target program according to the information acquisition instruction; and generating rendered data according to the data information, and sending the rendered data to the preset rendering carrier of the client to display the rendered data in the preset rendering carrier.

Based on the same concept, the present disclosure also provides a rendering control method, including: generating, in a debugging process for a target program, an information acquisition instruction for the target program by a preset rendering carrier, and sending the information acquisition instruction to an operating terminal to collect data information of the target program by the operating terminal, and generating rendered data corresponding to the data information; and receiving the rendered data from the operating terminal by the preset rendering carrier, and displaying the rendered data.

Based on the same concept, the present disclosure further provides a rendering control apparatus, including: an instruction receiving module, configured to receive an information acquisition instruction for a target program sent from a client by a preset rendering carrier; a data collection module, configured to collect data information of the target program according to the information acquisition instruction; and a rendering module, configured to generate rendered data according to the data information, and send the rendered data to the preset rendering carrier of the client to display the rendered data in the preset rendering carrier.

Based on the same concept, the present disclosure also provides a rendering control apparatus, including: an instruction generation module, configured to generate, in a debugging process for a target program, an information acquisition instruction for the target program by a preset rendering carrier, and send the information acquisition instruction to an operating terminal to collect data information of the target program by the operating terminal, and generate rendered data corresponding to the data information; and a display module, configured to receive the rendered data from the operating terminal by the preset rendering carrier, and displaying the rendered data.

Based on the same concept, the present disclosure also provides an electronic device, including a memory, a processor, and a computer program that is stored in the memory and capable of running in the processor, where the processor, when performing the computer program, implements the above-mentioned method.

Based on the same concept, the present disclosure also provides a non-transitory computer-readable storage medium storing computer instructions, where the computer instructions, when performed by a computer, are configured to perform the above-mentioned method.

Based on the same concept, the present disclosure also provides a computer program product, which includes computer program instructions. The computer, when running the computer program instructions, is configured to perform the above-mentioned method.

As can be seen from the above, the rendering control method, apparatus, electronic device, storage medium and program product provided by the present disclosure can receive the information acquisition instruction for the target program sent from the client by the preset rendering carrier, and then perform data interaction with the client based on the preset rendering carrier, without switching back and forth; it also can perform data information collection on the target program according to the information acquisition instruction, directly generate corresponding rendered data after collection, and directly send the rendered data to the client to be displayed on the preset rendering carrier. The process of generating the rendered data according to the data information is completed locally, it is not needed to execute the rendering process at the client, therefore, the client only needs to set the preset rendering carrier, and there is no need to adapt to corresponding rendering demand data, which reduces the adaptation of the client, is convenient and fast to operate, and can adapt to various clients, with a wide range of adaptation.

### BRIEF DESCRIPTION OF DRAWINGS

To more clearly illustrate the technical solutions in the present disclosure or related technologies, the accompanying drawings required for the description of the embodiments or related technologies will be briefly introduced below. Obviously, the accompanying drawings in the following description are merely embodiments of the present disclosure. For those of ordinary skill in the art, other accompanying drawings can also be obtained based on these drawings without exerting creative efforts.

FIG. 1 is a schematic diagram of data display in a unified rendering mode in related technology;

FIG. 2 is a schematic diagram of application scenarios according to an embodiment of the present disclosure;

FIG. 3 is a flowchart of a rendering control method according to an embodiment of the present disclosure;

FIG. 4 is a flowchart of a rendering control method according to the other embodiment of the present disclosure;

FIG. 5 is a schematic diagram of a framework between a PC device and the XR device according to an embodiment of the present disclosure;

FIG. 6 is a schematic flow diagram of simulating a user to pull out an Application 1 in an XR device by a PC device according to an embodiment of the present disclosure;

FIG. 7 is a schematic diagram of acquiring data information of single Application in an Example 1 according to an embodiment of the present disclosure;

FIG. 8 is a schematic diagram of acquiring data information of a group of Applications in an Example 1 according to an embodiment of the present disclosure;

FIG. 9 is a structural block diagram of a rendering control apparatus according to an embodiment of the present disclosure;

FIG. 10 is a structural block diagram of a rendering control apparatus according to the other embodiment of the present disclosure; and

FIG. 11 is a schematic structural diagram of an electronic device according to an embodiment of the present disclosure.

### DETAILED DESCRIPTION

It is to be understood that data involved in this technical solution (including but not limited to the data itself, acquisition or use of data) shall comply with the requirements of relevant laws and regulations and relevant provisions.

The principle and spirit of the present disclosure are described below with reference to a number of exemplary embodiments. It is to be understood that these embodiments are given only to enable those skilled in the art to better understand and thus realize the present disclosure, and not to limit the scope of the disclosure in any way. Rather, these embodiments are provided to make the present disclosure more thorough and complete, and to enable the scope of the present disclosure to be communicated in its entirety to those skilled in the art.

It is to be understood that before using the technical solutions disclosed in each embodiment of the present disclosure, it is needed to inform the type, scope of use, and use scenarios of the personal information involved in the present disclosure to a user and gain the authorization of the user through appropriate methods.

For example, prompt information is sent to the user in response to an active request of the user so as to clearly prompt the user, the operation requested to be executed needs to gain and use the personal information of the user. Therefore, the user can autonomously select whether to provide personal information for software or hardware such as an electronic device, an application, a server or a storage medium executing the operation of the technical solution of the present disclosure according to the prompt information.

As an optional but non-limited implementation, the manner of sending the prompt information to the user in response to receiving the active request of the user can be a popup window manner, and the prompt information can be presented in a character manner in the popup window. In addition, the popup window can also carry a selection control for the user to select “Agree” or “Disagree” to provide personal information for the electronic device.

It is to be understood that the above-mentioned processing of informing and gaining the authorization of the user is only indicative and do not limit the implementation of the present disclosure, and other implementations that meet the relevant laws and regulations can also be applied to the implementation of the present disclosure.

Herein, it is to be understood that any number of elements in the accompanying drawings is used as examples and not as a limitation, and that any nomenclature is only used for distinguishing and does not have any limiting implications.

### Terms

XR: Extended Reality, which includes at least one of the following: AR, VR, and MR.

AR: Augmented Reality.

VR: Virtual Reality.

MR: Mixed Reality.

APP: APPlication.

PC: Personal Computer.

Based on the description of the above background technology, the following situations exist in the relevant technology:

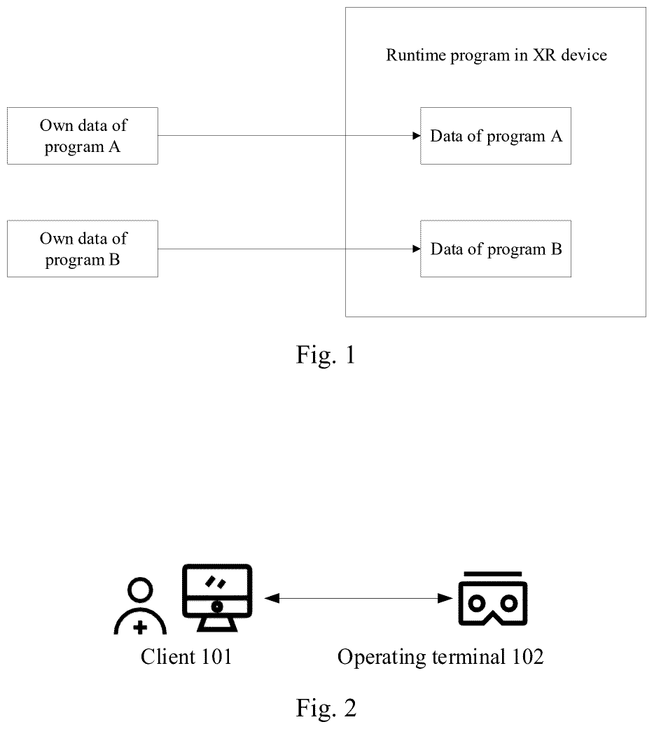

For some wearable display XR devices, the displayed interface will contain realistic scene pictures and pictures of programs that are positioned in scenarios, and the presentation of the finally rendered picture in this form cannot be controlled by a single program, but requires a system-level application to manage all the information to be rendered and complete the unified rendering, so the development form of unified rendering of the XR is more different from previous independent programs. In traditional program development, if monitoring the status of the program, it is only needed to focus on the program itself to get all the valid information, but it is different in the unified rendering mode, the core difference is that the status and data of the program are divided into two parts in FIG. 1:
1. Data of the program itself, such as the own data of programs A and B in the figure.
2. Data submitted to a Runtime program in the XR for uniform rendering.

As shown in FIG. 1, if observing the current status and data of a program, it is not enough to monitor the program itself (for example, data in the programs A and B at the left of the figure), it is needed to combine the data in the Runtime with the program itself to obtain complete data information and call links.

Based on the above description, there are problems as follows:
1. The debugging process is complicated, it needs at least two operations to send instructions to the program and Runtime respectively to pull relevant log information, and then it needs manually merge the two logs to get the complete program information, and there is a lack of means to obtain data on both sides at the same time and merge the required complete information for developers.
2. The final rendering performance of unified rendering is in the relevant XR device, and the developers perform program debugging in respective PC devices (windows, mac machines), and it is needed to switch back and forth between the XR device and the PC device frequently, which is more cumbersome.

As described above, the principles and spirit of the present disclosure are explained in detail below with reference to some representative embodiments of the present disclosure.

With reference to FIG. 2, it is a schematic diagram of program scenarios of a rendering control method provided by an embodiment of the present disclosure. The program scenarios include a client 101 and an operating terminal 102. The client 101 and the operating terminal 102 can be connected via a wired or wireless communication network. The client 101 and the operating terminal 102 include but are not limited to desktop computers, mobile phones, mobile computers, tablet computers, media players, smart wearable devices, personal digital assistants (PDAs), vehicle-mounted terminals or other electronic devices that can realize the above functions.

During debugging for a target program, both the client and the operating terminal run this target program. The client will set a preset rendering carrier, generate an information acquisition instruction for the target program by the preset rendering carrier, and send the information acquisition instruction to the operating terminal. The operating terminal will collect data information of the target program according to the information acquisition instruction, generate rendered data based on the data information, and send the rendered data to the preset rendering carrier of the client. In this way, the client will directly display the rendered data on the preset rendering carrier. Therefore, an original debugging target program can be displayed directly on the client, moreover, the relevant data information of the target program on the operating terminal can also be displayed by the preset rendering carrier, thus the purpose of monitoring the target program of the client itself and the target program of the operating terminal at the same time is achieved; and moreover, the client only needs to set the preset rendering carrier, and there is no need to adapt to corresponding rendering demand data, which reduces the adaptation of the client, is convenient and fast to operate, and can adapt to various clients, with a wide range of adaptation.

In addition, the client is preferably a PC, and the corresponding operating client is preferably the XR device, which can communicate with the PC and can realize the display and data interaction of some target programs. In the debugging process for the target program, the data of debugging and running of the target program will be provided on the PC side, and the data information of the running of the target program will be also available on the XR side simultaneously. Through the solution of the embodiment, while not making any program improvement on the PC, the relevant data information of the target program in the XR can also be displayed by the preset rendering carrier, so that the user can be convenient to determine the debugging effect.

The rendering control method according to the exemplary embodiment of the present disclosure is described below in conjunction with the application scenarios in FIG. 2. It is to be noted that the above-mentioned application scenarios are only shown for the convenience of understanding the spirit and principle of the present disclosure, and the embodiment of the present disclosure is not subject to any restrictions in this regard. Rather, the embodiment of the present disclosure may be applied to any applicable scenario.

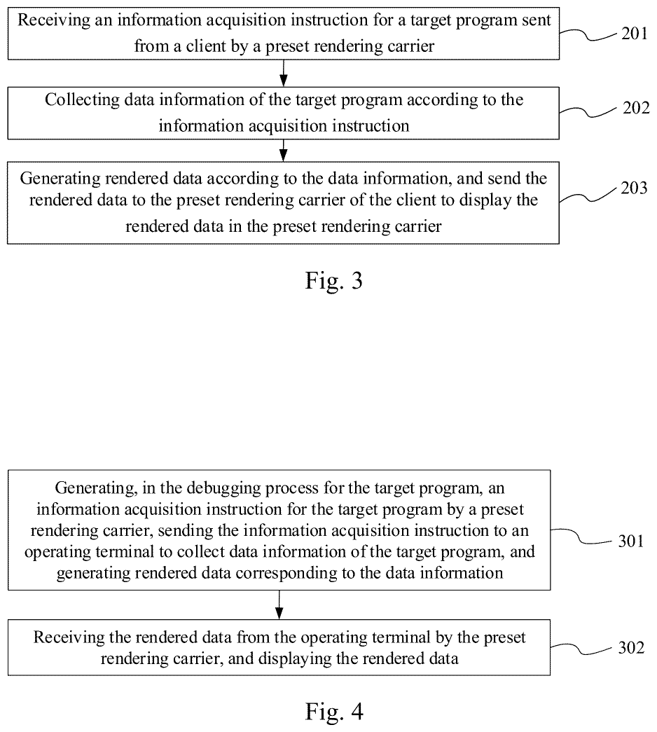

An embodiment of the present disclosure provides a rendering control method which applied to an operating terminal (such as a XR device). As shown in FIG. 3, the method includes:
Step 201: receiving an information acquisition instruction for a target program sent from a client by a preset rendering carrier.

In specific implementation, one preset rendering carrier will be set in the client, and a communication connection will be established with the operating terminal for data interaction by the preset rendering carrier. The preset rendering carrier includes: a browser or a target APP selected from all application APPs. The preset rendering carrier is configured to establish a communication channel with the operating terminal and display data content fed back by the operating terminal.

After the operating terminal establishes communication connection with the preset rendering carrier of the client, and if the client wants to acquire information for the target program in the operating terminal, the information acquisition instruction for the target program will be sent to the operating terminal by the preset rendering carrier.

Step 202: collecting data information of the target program according to the information acquisition instruction.

In specific implementation, after the operating terminal receives the information acquisition instruction for the target program, the data information in the running process of the target program will be determined from the operating terminal. The data information includes: an execution log, displayed data content, stored data and the like.

Step 203: generating rendered data according to the data information, and sending the rendered data to the preset rendering carrier of the client to display the rendered data in the preset rendering carrier.

In specific implementation, after the operating terminal collects the data information of the target program, the corresponding rendered data (such as specific color, and display position size of all the data information) will be generated at the operating terminal according to the data information, and the operating terminal will directly send the obtained the rendered data to the preset rendering carrier of the client. In this way, the preset rendering carrier of the client serves as a display window to directly display the rendered data, and the client does not need to adapt the data related to the rendering display of the operating terminal.

By the above solution, it can receive the information acquisition instruction for the target program sent from the client by the preset rendering carrier, and then perform data interaction with the client based on the preset rendering carrier, without switching back and forth; it also can perform data information collection on the target program according to the information acquisition instruction, directly generate corresponding rendered data after collection, and directly send the rendered data to the client to be displayed on the preset rendering carrier. The process of generating the rendered data according to the data information is completed locally, it is not needed to execute the rendering process at the client, therefore, the client only needs to set the preset rendering carrier, and there is no need to adapt to corresponding rendering demand data, which reduces the adaptation of the client, is convenient and fast to operate, and can adapt to various clients, with a wide range of adaptation.

In some embodiments, before step 201, the method further includes:
Step A1: receiving an access request from the client using the preset rendering carrier.

In specific implementation, the client will send the access request (such as an access website or an access data code (like a two-dimensional code) of the operating terminal) by the preset rendering carrier to establish communication connection with the operating terminal. Therefore, the operating terminal will receive the access request and then establish a communication connection with the preset rendering carrier of the client.

Step A2: determining, based on the access request, at least one program in running, and generating an operation interface containing the at least one program.

In specific implementation, when the operating terminal establishes the communication connection with the preset rendering carrier of the client, the at least one program in running of the operating terminal will be determined according to the access request. The at least one program is arranged and displayed, then a corresponding operation interface is generated, and rendering is performed according to the operation interface to obtain the operation interface containing the at least one program.

Step A3: sending the operation interface to the preset rendering carrier of the client to display the operation interface in the preset rendering carrier, and determining the target program from the at least one program by the operation interface.

In specific implementation, the operating terminal sends the rendered operation interface to the preset rendering carrier of the client, therefore, the operation interface containing the at least one program can be displayed in the preset rendering carrier, the user can select the required target program from the at least one program by the operation interface, and the information acquisition instruction for the target program is generated at the client. The target program can be one or more of the at least one program. Then, steps 201 to 203 can be continuously executed.

In addition, if there is no program in running in the operating terminal, prompt information will be generated and sent to the preset rendering carrier of the client, and the prompt information will be displayed by the preset rendering carrier.

Through the above solution, the operation interface for displaying at least one program in running can be provided for the client so that the user can select programs by the operation interface on the client and can select the most needed target program, so that the convenience of use of the user is ensured.

In some embodiments, step 202 includes:
Step 2021: determining the number of target programs according to the information acquisition instruction.
Step 2022: determining an information collection manner according to the number of the target programs, and collecting data information of the target programs according to the information collection manner.

In specific implementation, the operating terminal includes: a Runtime system, which is configured to implement various tasks for program running. The operating terminal is in communication connection with the preset rendering carrier of the client for data interaction by the Runtime system.

After receiving the information acquisition instruction, the Runtime system will count the number of target programs in the information acquisition instruction, and then determine the most proper information collection manner according to the number, and therefore, data information of the target programs can be faster and more convenient to collect according to the information collection manner. The information collection manners corresponding to various numbers are preset.

Through the above solution, the most proper information collection manner can be determined according to the number of the target programs, and therefore, the data information of the target programs can be faster and more convenient to collect according to the information collection manner.

In some embodiments, step 2022 includes:
Step B1: determining, in response to determining that a single target program is provided, whether the data information of the single target program is stored.

Step B2: collecting, in response to determining that the data information of the single target program is stored, the data information of the single target program.

Or, step B3: retrieving, in response to determining that the data information of the single target program is not stored, the data information from the single target program, and collecting the data information of the single target program.

In specific implementation, the Runtime system will continuously monitor the data of each program running in the operating terminal, and may store the data of the program in running. Therefore, after the Runtime system determines that single target program is provided, it will determine whether there is the data information of the single target program in the Runtime system. Specifically, a first service module (such as a RemoteMonitor Server set in the Runtime) in the Runtime system is utilized to determine whether the data information of the single target program is stored.

If yes, the Runtime system will directly collect the data information of the single target program, directly render the data information to obtain corresponding rendered data, and send the rendered data to the preset rendering carrier of the client for display.

If not, the Runtime system will generate a retrieving request and send the retrieving request to the target program, and after receiving the retrieving request, the target program will send the data information to the Runtime system, so that the Runtime system can collect and render the data information to obtain the corresponding rendered data, and send the rendered data to the preset rendering carrier of the client for display.

Through the above solution, the collection and rendering process of the single target program can be completed, and the operation is simple and convenient.

In addition, if the target program stops running in the process that the Runtime system retrieves the data information from the single target program, the Runtime system will generate prompt information, send the prompt information to the preset rendering carrier of the client and display the prompt information so as to prompt the user that the data information of the target program is retrieved unsuccessfully.

In some embodiments, step 2022 includes:
Step C1: determining, in response to determining that a plurality of target programs are provided, whether all data information of the plurality of target programs is stored.

In specific implementation, the Runtime system will continuously monitor the data of each program running in the operating terminal, and may store the data of the programs in running. Therefore, all data information or part of the data information of the plurality of target programs may be stored in the Runtime system, or the data information of the plurality of target programs may not be stored.

Whether to retrieve data from the corresponding target program is determined by determining whether all the data information of the plurality of target programs is stored in the Runtime system. Specifically, the first service module (such as the RemoteMonitor Server set in the Runtime) in the Runtime system is utilized to determine whether all the data information of the plurality of target programs is stored.

Step C2: collecting, in response to determining that all the data information of the plurality of target programs is stored, all the data information of the plurality of target programs.

In specific implementation, after determining that all the data information of the plurality of target programs is stored in the Runtime system, all the data information is collected together and then integrated, all the data information is rendered after integration is completed, and the process of step 203 is continuously executed.

Or, step C3: determining, in response to determining that not all data information of the plurality of target programs is stored, the target programs without data information, traversing the target programs without data information one by one to retrieve the corresponding data information until the data information of all the target programs is obtained, and collecting all the data information of the plurality of target programs.

In specific implementation, it is determined that all the data information of the plurality of target programs is not stored in the Runtime system. Specifically, it is possible that all the data information of the plurality of target programs may not be stored, or part of the data information of the plurality of target programs may not be stored, whether all or part of the data information is not stored or not, the target programs without data information will be determined, and then the corresponding data information will be retrieved by one-by-one traversal. The one-by-one traversal is to perform sequential serial traversal according to a sequence or parallel traversal, and to improve the running speed, parallel traversal is preferred in the embodiment.

Through the above solution, whether all the data information of the plurality of target programs is stored in the Runtime system, according to the above solution, all the data information can be finally obtained, and collected and integrated, then rendered to obtain the final rendered data, and send to the preset rendering carrier of the client for direct display.

In some embodiments, the step C3 of traversing the target programs without data information one by one to retrieve the corresponding data information includes:
Step C31: sending a data calling request to each target program without data information, and determining whether the data information fed back by the target programs without data information is received within a preset time length.

In specific implementation, the data calling request is sent to a second service module (such as a RemoteMonitor Server set in a target program Application) in the target program without data information by the first service module (such as the RemoteMonitor Server set in the Runtime) in thee Runtime system. After the data calling request is sent, the first service module starts to perform timing, and continuously determine whether the data information fed back by the target program without data information is received or not within the preset time length.

Step C32: determining, in response to determining that the data information fed back by the target program without data information is not received within the preset time length, a processing strategy according to the running status of the target program without data information, and performing control processing on the target program without data information according to the processing strategy.

In specific implementation, if the data information fed back by the target program without data information is not received after the timing within the preset time length is finished, the target program may be stuck, the target program may stop running, or the target program may be abnormal, therefore, the corresponding processing strategy will be determined according to different running statuses, and then the target program will be controlled according to the processing strategy.

Or, step C33: collecting, in response to determining that the data information fed back by the target program without data information is received within the preset time length, the fed back data information.

In specific implementation, if the data information fed back by the target program without data information is received before the timing within the preset time length is finished, the data information of the same target program will be integrated, and then the data information of all the target programs will be collected.

Through the above solution, a preset time length will be set for the feedback process of each target program without data information, so that if the data information fed back is not received after exceeding the preset time length, the processing strategy can be determined in time according to the running status of the target program without data information, then the control can be carried out according to the processing strategy, and as a result, the situation that the subsequent rendering collection process is affected due to that the target program is in a status of waiting for fed back all the time is avoided.

In some embodiments, step C32 includes:
Step C321: determining, in response to determining that the data information fed back by the target program without data information is not received within the preset time length, whether the running status of the target program without data information is a status of stopping running.
Step C322: ignoring, in response to determining that the running status of the target program without data information is the status of stopping running, the target program with stopped running.
Or, step C323: sending, in response to determining that the running status of the target program without data information is a status of running, the data retrieving request again until the data information fed back by the target program without data information is received, collecting the fed back data information, or, determining that the target program without data information is abnormal.

In specific implementation, if the first service module (such as the RemoteMonitor Server set in Runtime) in the Runtime system determines that the feedback of the target program without data information is not received after exceeding the preset time length, running status parameters of the target program without data information will be acquired, and whether the running is stopped will be determined according to the running status parameters. If the running is stopped, the corresponding data information is not needed to be collected again and it is directly ignored (such as deleted from the plurality of target programs). If it is in running, the first service module in the Runtime system will send the data calling request to the second service module (such as the RemoteMonitor Server set in the Application of the target program) in the target program without data information again, so as to call the data information again, and the above steps are repeated until the feedback data information is received or it is determined that the target program without data information is abnormal.

Through the above solution, under the condition that the data information fed back by the target program without data information is not received after exceeding the preset time length, it will be divided into the status of stopping running and the status of running according to the running status of the target program without data information, and the corresponding processing strategies will be configured for the two conditions respectively, so that the situation that feedback is waited all the time is effectively avoided, and the time is saved.

In some embodiments, step C323 includes:
Step C3231: sending, in response to determining that the running status of the target program without data information is the status of running, the data calling request again, and counting the sending times of the data calling request.
Step C3232: receiving, in response to determining that when the sending times is smaller than or equal to a times threshold, the data information fed back by the target program without data information, collecting the fed back data information. Or,
Step C3233: determining, in response to determining that the sending times is greater than the times threshold (such as 3 times, 4 times or 5 times) and the data information fed back by the target program without data information is not received, that the target program without data information is abnormal, recording abnormal data, and ignoring the target program without data information.

In specific implementation, if the data information fed back is not received after exceeding the preset time length and the running status of the target program without data information is the status of running, the first service module (such as the RemoteMonitor Server set in the Runtime) in the Runtime system will determine whether the target program without data information is abnormal or not according to the counted sending times of the data calling request. Therefore, the target program without data information in abnormal running can be found in time; and because the data information corresponding to the target program in abnormal running is inaccurate, it will be ignored (such as, deleted from the plurality of target programs).

Through the above solution, whether the target program without data information is abnormal or not can be accurately determined by counting the sending times of the data calling request, and it can be processed timely, so that the situation that feedback is waited all the time is effectively avoided, and time is saved.

In some embodiments, after the data information fed back by the target program without data information is received, whether the corresponding data information of all the target programs in running is collected will be determined, if yes, traversal is stopped, and if not, traversal will be continuously carried out on other target programs without data information.

Through the above solution, when the data information fed back by the target program without data information is received each time, whether the data information is completely fed back or not will be determined, and then subsequent collection and rendering process can be carried out timely after all the data information is fed back.

Based on the same inventive concept, corresponding to the rendering control method (such as the method applied to an operating terminal) described in each embodiment above, the rendering control method provided by this embodiment is specifically applied to the client (such as a desktop computer or a mobile computer), as shown in FIG. 4. The method includes:
Step 301: generating, in the debugging process for the target program, an information acquisition instruction for the target program by a preset rendering carrier, to send the information acquisition instruction to an operating terminal to collect data information of the target program, and generating rendered data corresponding to the data information.

In specific implementation, one preset rendering carrier will be set in the client, and a communication connection will be established with the operating terminal for data interaction by the preset rendering carrier. The preset rendering carrier includes: a browser or a target APP selected from all application APPs. The preset rendering carrier is configured to establish a communication channel with the operating terminal and display data content fed back by the operating terminal.

Specifically, during initial use, the user can select one preset rendering carrier from the browser or all application APPs according to needs, and after the preset rendering carrier is selected, in the debugging process, the preset rendering carrier can be directly configured to perform communication connection with the operating terminal, without repeatedly selecting the setting process. In addition, if it is needed to change the preset rendering carrier subsequently, the preset rendering carrier can be set and changed.

Then, if the user needs to refer to the data of the operating terminal running the target program in the process of debugging the target program by the client, the information acquisition instruction for the target program will be generated by the preset rendering carrier, thus the information acquisition instruction can be sent to the operating terminal, the operating terminal will execute data collection and rendering process according to the rendering control method in steps 101-103 of this embodiment, so as to obtain the corresponding rendered data of the target program.

Step 302: receiving the rendered data from the operating terminal by the preset rendering carrier, and displaying the rendered data.

In specific implementation, the preset rendering carrier of the client serves as a display window to directly display the rendered data, and the client does not need to adapt the data related to the rendering display of the operating terminal.

Through the above solution, the collection and rendering processes of the data information of the target program are executed at the operating terminal to obtain rendered data, and the client directly displays the rendered data in the preset rendering carrier, without executing the rendering process, therefore, the client only needs to set the preset rendering carrier, and there is no need to adapt to corresponding rendering demand data, which reduces the adaptation of the client, is convenient and fast to operate, and can adapt to various clients, with a wide range of adaptation.

In some embodiments, before step 301, the method further includes:
Step a1: sending an access request to the operating terminal by the preset rendering carrier, and then generating a corresponding operation interface according to at least one program in running by the operating terminal generates.

In specific implementation, the client will send the access request (such as an access website or an access data code (like a two-dimensional code) of the operating terminal) by the preset rendering carrier in order to establish communication connection with the operating terminal. Therefore the operating terminal will receive the access request and then establish a communication connection with the preset rendering carrier of the client. When the operating terminal establishes the communication connection with the preset rendering carrier of the client, the at least one program in running of the operating terminal will be determined according to the access request. The at least one program is arranged and displayed, then a corresponding operation interface is generated, and rendering is performed according to the operation interface to obtain the operation interface containing the at least one program.
Step a2: receiving the operation interface fed back by the operating terminal by the preset rendering carrier, and displaying the operation interface in the preset rendering carrier.
Step a3: receiving the target program selected from the at least one program by the operation interface.

In specific implementation, the user can select the required target program from the at least one program by the operation interface, and the information acquisition instruction for the target program is generated at the client. The target program can be one or more of the at least one program.

In addition, when there is no program running in the operating terminal, the operating terminal will feed back prompt information, render the prompt information and then feed back the prompt information to the client. The client will directly receive and display the prompt information by the preset rendering carrier.

Through the above solution, the process of selecting the target program is provided for the user, thus the user can conveniently select the corresponding target program according to actual needs, and more services are provided for the user.

Based on the same inventive concept, a PC side is used as the client, a XR device is used as the operating terminal, and which jointly implement the rendering control method of this embodiment, and the specific implementation process is as follows:
a RemoteMonitor (remote monitoring) function is provided to realize interaction with XR Runtime in the PC, and that running in the XR is called a RemoteMonitor Server side, and that running in the PC is called a RemoteMonitor Client side; and the user accesses the XR device using the Client in the PC, and the information is collected and integrated by the Server side in the XR device and returned to the Client of the user.

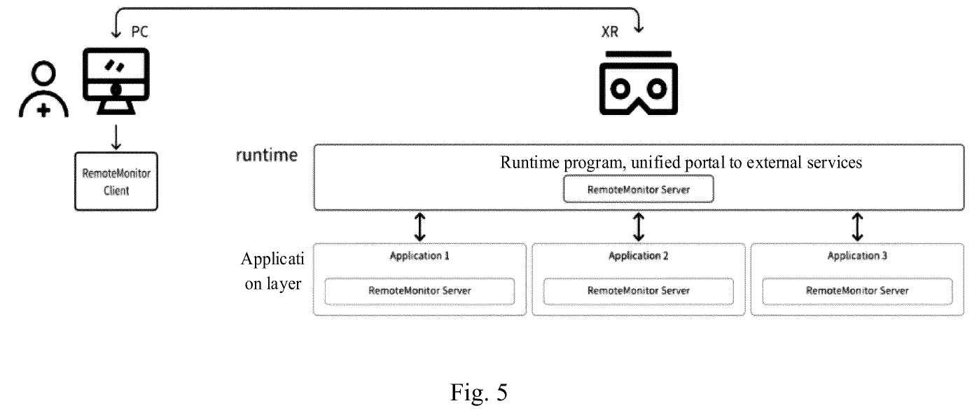

Shown as the framework in FIG. 5, the solution of this embodiment specifically includes the following three parts:

### I. Communication and Interaction Link between PC Device and XR Device

In order to complete debugging of the program only in the PC device, it is not needed to switch back and forth between the XR device and the PC device, it needs a set of cross-platform supporting framework to complete the debugging operation during development.

In order to adapt to various PC devices and simply interact with the XR device, the PC device is a computer with Windows, Mac, Linux and other systems. Therefore, a cross-platform requirement is put forward for the RemoteMonitor Client in this design, and to ensure cross-platform implementation, in this embodiment, there is a “browser existing” in any PC device is used as the Client of the RemoteMonitor.

The RemoteMonitor Server side in the XR device can interact with the browser (Client) in the PC device by implementing the service of supporting an Http request and a Websocket protocol. It is only needed to access a network port of the designated XR device in the browser of the PC device, so that the Server port in the Runtime in the XR device can be accessed to return webpage related codes, and then subsequent interaction can be completed.

### II. Data Interaction Link between Runtime in XR Device and Other Applications

It is needed to effectively degrade a complex link for pulling data information of a specified target program, so that the user (such as the developer) can simply and visually perform data observation on the target program in the debugging process of the target program.

According to this embodiment, the RemoteMonitor Server (namely, a first service module) in the Runtime in the XR device is reserved to implement interaction with the browser (Client) in PC device, and the Runtime of the XR device uniformly implements the distribution of internal instructions of the XR device and the collection process of the data information.

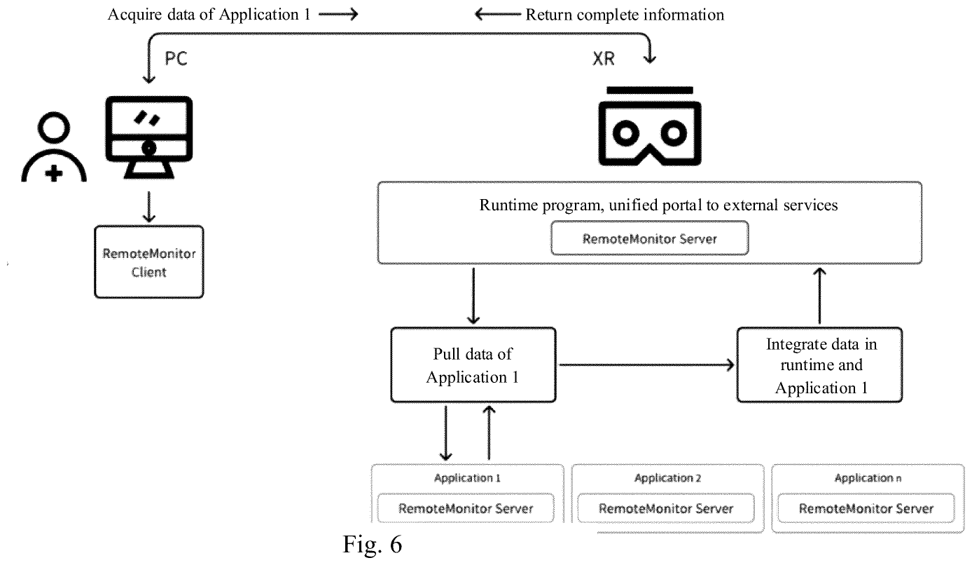

As shown in FIG. 6, the process of simulating a user to pull the data information of an Application 1 (namely, the target program) in the XR device by the PC device includes:
1: Accessing the address of the RemoteMonitor Server in the Runtime in the XR device by browser of the PC device.
2: Returning the rendered operation interface to the browser of the PC device by the RemoteMonitor Server in the XR device, displaying the operation interface in the browser of the PC device, and clicking the information acquisition instruction for pulling the data information of the Application 1 by the user using the operation interface.
3: After the Runtime in the XR device receives the information acquisition instruction, determining the data information of the Application 1.

Specifically, if the data information of the Application 1 is stored in the Runtime, the stored data information of the Application 1 will be directly retrieved.

If the data information of the Application 1 is not stored in the Runtime, the information acquisition instruction will be forwarded to the RemoteMonitor Server module (namely, the second Server module) in the Application 1 by the RemoteMonitor Server.
4: After the Application 1 collects the local data information, forwarding the local data information to the Runtime, integrating the complete information and rendering to obtain the rendered data by the Runtime, and returning the rendered data to the browser (RemoteMonitor Client) of the PC device, and displaying the rendered data in the browser.

The data collection and integration processes are specifically described in two examples:

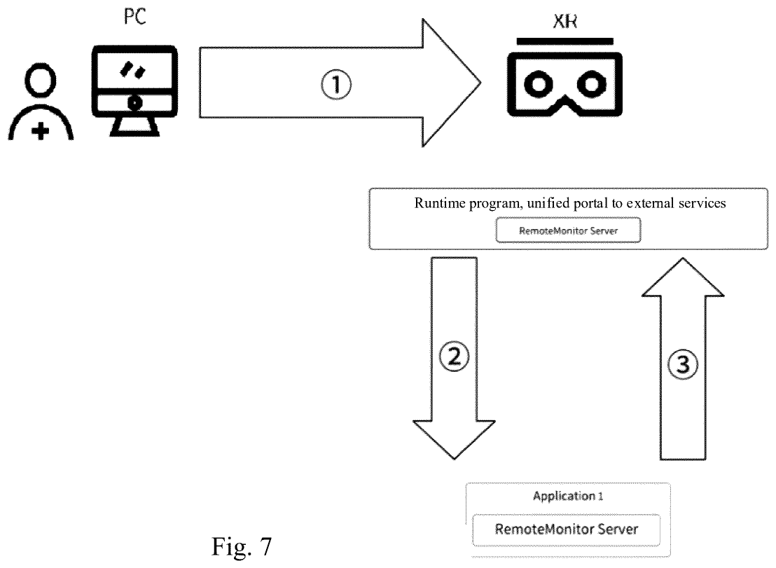

Example 1: Acquisition process for data information of single Application (target program):
1: Sending the information acquisition instruction to a RemoteMonitor Server (shown as \textcircled{1} in FIG. 7) in Runtime used externally of the XR device by the browser of the PC device.
2: After the RemoteMonitor Server in the Runtime receives the information acquisition instruction, determining that the information acquisition instruction corresponds to the required Application (target program), and determining whether the Runtime contains valid data information of the Application (target program).
a: If the Runtime contains the valid data information of the Application (target program), directly entering the rendering stage.
b: If the Runtime does not contain the valid data information of the Application (target program), retrieving the data information from the Application by the following two steps:
   i: Sending the data calling request to a RemoteMonitor Server (shown in \textcircled{2} in FIG. 7) of the Application.
   ii: receiving the data calling request by the RemoteMonitor Server of the Application, acquiring the local data information, and feeding back the data information to the Runtime (shown in \textcircled{3} in FIG. 7).
3: Rendering the data information by the Runtime to obtain view data (namely rendered data) of the data information, returning the view data to the browser of the PC device, and displays the view data by the browser (shown in \textcircled{4} in FIG. 7).

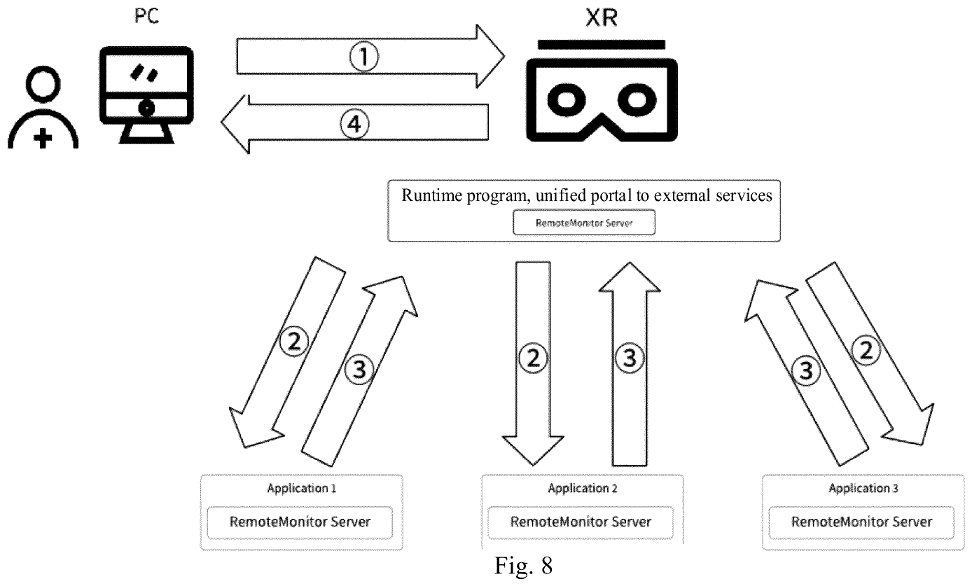

Example 2: Acquisition process of data information of a group of Applications (namely a plurality of target programs):
1: Sending the information acquisition instruction to the RemoteMonitor Server (as shown in \textcircled{1} in FIG. 8) in the Runtime used externally of the XR device by the browser of the PC device.
2: After the RemoteMonitor Server in the Runtime receives the information acquisition instruction, determining that the information acquisition instruction corresponds to the plurality of required Applications (namely the plurality of target programs), and determining whether the Runtime contains valid data information of all the Applications.
a: If the Runtime contains the valid data information of all the Applications, directly entering the rendering stage.
b: If the Runtime does not contain the valid data information of all the Applications, traversing the Applications without the data information one by one, and calling the data information by the following steps:
   i: Sending the data calling request to the RemoteMonitor Server (as shown in \textcircled{2} in FIG. 8) of the Application.
   ii: Receiving the data calling request by the RemoteMonitor Server of the Application, acquiring local data information, and feeding back the data information to the Runtime (as shown in \textcircled{3} in FIG. 8).

When receiving the data information replied by one Application, the Runtime will determine whether the data information of all the applications is received, if yes, the rendering stage will be performed, and if not, each application will be traversed:
if determining that the data calling request replied by the Application is not replied after exceeding the preset time length, the Runtime will determine whether the application is still running.
(1) If the Application is stopped running, the Application will be ignored, and whether all the application data information is received will be determined again.
(2) If the Application is in running, the data calling request will be sent again, and if the data calling request is sent more than n times, the Application will be determined to be abnormal, the abnormal condition will be recorded, and the application will be ignored.
3: Rendering the data information of all the Applications by the Runtime to obtain the view data (that is rendered data) of the data information of all the Applications, and returning the view data to the browser of the PC device, and displaying the view data by the browser (as shown in \textcircled{4} in FIG. 8).

### III. Design of Interactive Interface of Client in PC Device

The interactive interface is designed as that the data sent to the browser of the PC side by the Server side of the Runtime of the XR device is not data information, but is the complete rendered data obtained after rendering, the rendered data is sent to the Client of the browser of the PC device, and the Client directly displays the rendered data.

The mode has the advantages that the developer does not need to pay attention to language written by the Client of the browser of the PC device, and does not need to have a development code of the Client of the browser of any PC device, but after the XR device obtains the data information of all Applications, the Server side of Runtime will rendering the data information of the Applications to obtain the rendered data.

Finally, the Runtime will send the rendered data to the Client of the browser of the PC device, the Client of the browser is a Monitor, and it is only configured to display the rendered data obtained by rendering by the Server side of the Runtime, monitor the IO operations such as a mouse and a keyboard on the PC device, and forward the operation instruction to the Server side of Runtime; and the Server side of the Runtime will generate subsequent rendered data according to the information of the mouse and the keyboard and then distribute the subsequent rendered data to the Client of the browser of the PC device.

It is to be noted that the method provided by the embodiment of the present disclosure can be executed by a single device, such as a computer or a server. The method provided by the embodiment of the present disclosure can also be applied to distributed scenarios and is implemented by a plurality of devices in cooperation. In the case of the distributed scenarios, one of the plurality of devices can only execute one or more steps in the method provided by the embodiment of the present disclosure, and the plurality of devices will interact with one another to implement the method.

It is to be noted that the forgoing is to describe some embodiments of the present disclosure. Other embodiments are attached to the claims. In some cases, actions or steps in the claims can still be executed according to a sequence different from the sequence in the embodiments above and expected results can be still realized. In addition, the processes described in the accompanying drawings are not necessarily required to show a specific sequence or a result which can be realized continuously. In some embodiments, multi-task processing and parallel processing can also be beneficial or possibly beneficial.

Based on the same concept, corresponding to the rendering control method in the corresponding embodiment in FIG. 3, the present disclosure also provides a rendering control apparatus. The rendering control apparatus is arranged at the operating terminal.

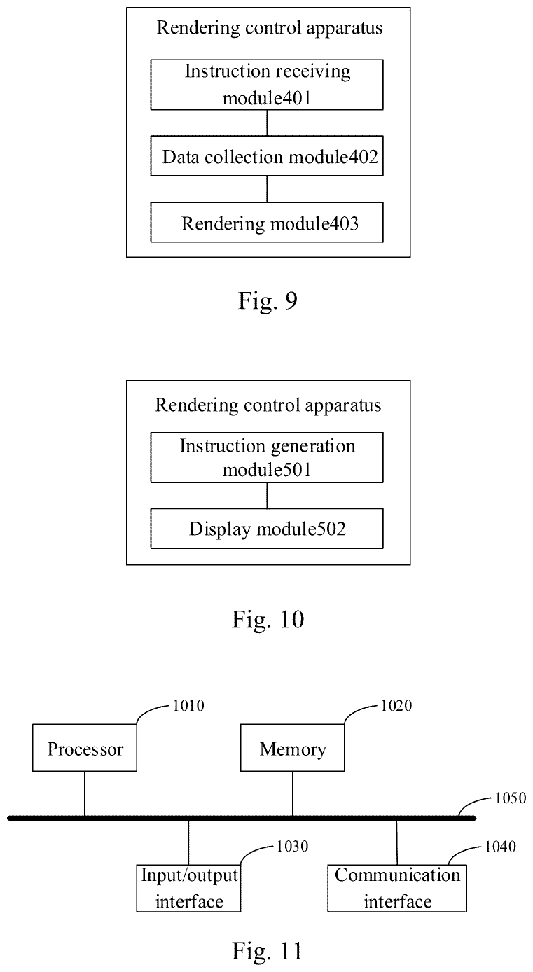

With reference to FIG. 9, the apparatus includes: an instruction receiving module 401, configured to receive an information acquisition instruction for a target program sent from a client by a preset rendering carrier; a data collection module 402, configured to collect data information of the target program according to the information acquisition instruction; and a rendering module 403, configured to generate rendered data according to the data information, and send the rendered data to the preset rendering carrier of the client to display the rendered data in the preset rendering carrier.

In some embodiments, the apparatus also includes: an operation interface generation module which is configured to: before receiving the information acquisition instruction for the target program sent by the client using the preset rendering carrier, receive an access request from the client using the preset rendering carrier; determine, based on the access request, at least one program in running, and generate an operation interface containing the at least one program; and send the operation interface to the preset rendering carrier of the client to display the operation interface in the preset rendering carrier, and to determine the target program from the at least one program by the operation interface.

In some embodiments, the data collection module 402 includes: a number determination unit, configured to determine the number of target programs according to the information acquisition instruction; and a data collection unit, configured to determine an information collection manner according to the number of the target programs, and collect data information of the target programs according to the information collection manner.

In some embodiments, the data collection unit is specifically configured to: determine, in response to determining that a single target program is provided, whether the data information of the single target program is stored; and collect, in response to determining that the data information of the single target program is stored, the data information of the single target program; or, retrieve, in response to determining that the data information of the single target program is not stored, the data information from the single target program, and collect the data information of the single target program.

In some embodiments, the data collection unit is also specifically configured to: determine, in response to determining that a plurality of target programs are provided, whether all data information of the plurality of target programs is stored; and collect, in response to determining that all the data information of the plurality of target programs is stored, all the data information of the plurality of target programs; or determine, in response to determining that not all data information of the plurality of target programs is stored, the target programs without data information, traverse the target programs without data information one by one to retrieve the corresponding data information until the data information of all the target programs is obtained, and collect all the data information of the plurality of target programs.

In some embodiments, the data collection unit is also specifically configured to: send a data calling request to each target program without data information, and determine whether the data information fed back by the target programs without data information is received within a preset time length; and determine, in response to determining that the data information fed back by the target program without data information is not received within the preset time length, a processing strategy according to the running status of the target program without data information, and perform control processing on the target program without data information according to the processing strategy; or collect, in response to determining that the data information fed back by the target program without data information is received within the preset time length, the fed back data information.

In some embodiments, the data collection unit is also specifically configured to: determine, in response to determining that the data information fed back by the target program without data information is not received within the preset time length, whether the running status of the target program without data information is a status of stopping running; and ignore, in response to determining that the running status of the target program without data information is the status of stopping running, the target program with stopped running; or send, in response to determining that the running status of the target program without data information is a status of running, the data calling request again until the data information fed back by the target program without data information is received, collect the fed back data information, or, determine that the target program without data information is abnormal.

In some embodiments, the data collection unit is also specifically configured to: send, in response to determining that the running status of the target program without data information is the status of running, the data calling request again, and count the sending times of the data calling request; and receive, in response to determining that when the sending times is smaller than or equal to a times threshold, the data information fed back by the target program without data information, collect the fed back data information; or determine, in response to determining that the sending times is greater than the times threshold and the data information fed back by the target program without data information is not received, that the target program without data information is abnormal, record abnormal data, and ignore the target program without data information.

In some embodiments, the data collection unit is also specifically configured to: determine, after the fed back data information fed is received, whether the corresponding data information of all the target programs in running is collected, if yes, stop traversing, and if not, continuously traverse.

Based on the same inventive concept, corresponding to the rendering control method in the embodiment show in FIG. 4, this embodiment provides a rendering control apparatus which is arranged at the client.

As shown in FIG. 10, the apparatus includes: an instruction generation module 501, configured to generate, in the debugging process for the target program, an information acquisition instruction for the target program by a preset rendering carrier, send the information acquisition instruction to an operating terminal to collect data information of the target program by the operating terminal, and generate rendered data corresponding to the data information; and a display module 502, configured to receive the rendered data from the operating terminal by the preset rendering carrier, and display the rendered data.

In some embodiments, the apparatus further includes a selection module configured to: send, before generating the information acquisition instruction for the target program by the preset rendering carrier, an access request to the operating terminal by the preset rendering carrier, and then generate a corresponding operation interface according to at least one program in running by the operating terminal generates; receive the operation interface fed back by the operating terminal by the preset rendering carrier, and display the operation interface in the preset rendering carrier; and receive the target program selected from the at least one program by the operation interface.

For the convenience of description, the above apparatuses are described by function and divided into various modules. The functions of each module may be implemented definitely in the same or more software and/or hardware in the implementation of the present disclosure.

The apparatus of the above embodiment is configured to implement the corresponding method in any of the above embodiments, and has the beneficial effect of the corresponding method embodiment, which will not be listed herein.

Based on the same conception, corresponding to the method of any above embodiment, the present disclosure also provides an electronic device, which includes a memory, a processor, and a computer program that is stored on the memory and capable of running in the processor, and the processor implements the method described in any of the above embodiments when executing the program.

FIG. 11 is a more specific schematic diagram of a hardware structure of an electronic device provided by the embodiment, and the device may include: a processor 1010, a memory 1020, an input/output interface 1030, a communication interface 1040 and a bus 1050. The processor 1010, the memory 1020, the input/output interface 1030 and the communication interface 1040 realize the communication connection with each other within the device through the bus 1050.

The processor 1010 can be implemented by a general CPU (Central Processing Unit), a microprocessor, an Application Specific Integrated Circuit (ASIC), or one or more integrated circuits, etc., and is configured to execute related programs so to realize the technical solution provided by the embodiment of this specification.

The memory 1020 can be implemented in a form of an ROM (Read Only Memory), an RAM (Random Access Memory), a static storage device, a dynamic storage device, etc. The memory 1020 can store the operating system and other applications; and when the technical solution provided by the embodiment of this specification is implemented by software or firmware, relevant program codes are saved in the memory 1020 and are called and executed by the processor 1010.

The input/output interface 1030 is configured to connect the input/output module to realize information input and output. The input/output/module can be used as a component in the device (not shown in the figure) or externally connected to the device to provide corresponding function. The input device can include a keyboard, a mouse, a touch screen, a microphone, various sensors, etc., and the output device can include a display, a speaker, a vibrator, an indicator light, etc.

The communication interface 1040 is connected to a communication module (not shown in the figure) to realize the communication interaction between this device and other devices. The communication module can realize communication by a wired mode (such as USB, and network cable), and can also realize communication by a wireless mode (such as mobile network, WIFI, and Bluetooth).

The bus 1050 includes a pathway that transmits information between various components of the device (such as the processor 1010, the memory 1020, the input/output interface 1030, and the communication interface 1040).

It is to be noted that although the above-mentioned device only shows the processor 1010, the memory 1020, the input/output interface 1030, the communication interface 1040 and the bus 1050, the device may also include other components necessary for implementing normal operation in the specific embodiment. In addition, it is to be understood by those skilled in the art that the above-mentioned devices may also contain only the components necessary to realize the solution of the embodiment of this specification, and not all the components shown in the accompanying drawings.

The electronic device in the above embodiment is configured to implement the corresponding rendering control method in any of the above embodiments, and has the beneficial effect of the corresponding embodiment of the rendering control method, which will not be listed herein.

Based on the same conception, and corresponding to the method of any above embodiment, the present disclosure also provides a non-transitory computer-readable storage medium which stores computer instructions, and the computer instructions are used for driving the computer to perform the method described in any of the above embodiments.

The computer-readable medium in the embodiment includes permanent and non-permanent, movable and non-removable media, and information storage may be realized by any method or technology. The information can be computer-readable instructions, data structures, modules of programs, or other data. Examples of the computer storage medium include, but are not limited to, a phase change memory (PRAM), a static random access memory (SRAM), a dynamic random access memory (DRAM), other types of random access memory (RAM), a read-only memory (ROM), an electrically erasable programmable read-only memory (EEPROM), a flash memory or other memory technology, a read-only optical disc read-only memory (CD-ROM), a digital multi-function disc (DVD) or other optical storage, and a magnetic cartridge tape; and a magnetic disk storage or other magnetic storage device, or any other non-transport medium, can be configured to store information that can be accessed by computing devices.

The computer instructions stored in the storage medium of the above embodiment is used for making the computer perform the method described in any of the above embodiments, and has the beneficial effect of the corresponding method embodiment, which will not be listed herein.

Based on the same conception, and corresponding to the above-mentioned any method embodiments, the present disclosure also provides a computer program product, which includes computer program instructions, and when the computer program instructions are run in the computer, the computer is made to perform the method in any of the above embodiments and has the beneficial effects of the corresponding method embodiment, which will not be listed herein.

Those of ordinary skill in the art should understand that the discussion of any of the above embodiments is illustrative only and is not intended to imply that the scope (including the claims) of the present disclosure is limited to these examples; under the concept of the present disclosure, the above embodiments or the technical features in the different embodiments may also be combined, and the steps may be implemented in any sequence, and there are many other variations of the different aspects of the embodiments of the present disclosure as described above, which are not provided in detail for the sake of brevity.

In addition, for the sake of simplification of the description and discussion, and in order not to make the embodiment of the present disclosure difficult to understand, the well-known power/ground connection to the integrated circuit (IC) chip and other components may or may not be shown in the provided accompanying drawings. In addition, the apparatus may be shown in a form of a block diagram in order to avoid making the embodiments of the present disclosure difficult to understand, and this also takes into account the fact that the details of the embodiments of the apparatus in these block diagram are highly dependent on the platform on which the embodiments of the present disclosure are to be implemented (i.e., these details should be well within the comprehension of those skilled in the art). Where specific details (e.g., circuits) have been elaborated to describe an exemplary embodiment of the present disclosure, it is obvious to those skilled in the art that the embodiment of the present disclosure can be implemented in the absence of such specific details or with variations in those specific details. Therefore, these descriptions should be considered illustrative rather than restrictive.

Although the present disclosure has been described in conjunction with the specific embodiments of the present disclosure, many substitutions, modifications and variants of these embodiments will be obvious to those of ordinary skill in the art according to the preceding descriptions. For example, other memory architectures (e.g., dynamic RAM (DRAM)) can use the embodiment in question.

The embodiments of the present disclosure are intended to cover all such substitutions, modifications and variants that fall within the broad scope of the appended claims. Therefore, any omissions, modifications, equivalent substitutions, improvements, etc., made within the spirit and principles of the embodiments of the present disclosure shall be included in the scope of protection of the present disclosure.

1. A rendering control method, comprising:
receiving an information acquisition instruction for a target program sent from a client by a rendering carrier;
collecting data information of the target program according to the information acquisition instruction; and
generating rendered data according to the data information, and sending the rendered data to the rendering carrier of the client to display the rendered data in the rendering carrier.

2. The method of claim 1, wherein before receiving the information acquisition instruction for the target program sent by the client using the rendering carrier, the method further comprises:
receiving an access request from the client using the rendering carrier;
determining, based on the access request, at least one program in running, and generating an operation interface comprising the at least one program; and
sending the operation interface to the rendering carrier of the client to display the operation interface in the rendering carrier, and to determine the target program from the at least one program by the operation interface.

3. The method of claim 1, wherein the collecting the data information of the target program according to the information acquisition instruction comprises:
determining a number of target programs according to the information acquisition instruction; and
determining an information collection manner according to the number of the target programs, and collecting data information of the target programs according to the information collection manner.

4. The method of claim 3, wherein the determining the information collection manner according to the number of the target programs, and collecting the data information of the target programs according to the information collection manner comprises:
determining, in response to determining that a single target program is provided, whether data information of the single target program is stored; and
collecting, in response to determining that the data information of the single target program is stored, the single piece of data information of the single target program; or
retrieving, in response to determining that the data information of the single target program is not stored, data information from the single target program, and collecting the data information of the single target program.

5. The method of claim 3, wherein the determining the information collection manner according to the number of the target programs, and collecting data information of the target programs according to the information collection manner comprises:
determining, in response to determining that a plurality of target programs are provided, whether all data information of the plurality of target programs is stored; and
collecting, in response to determining that all the data information of the plurality of target programs is stored, all the data information of the plurality of target programs; or
determining, in response to determining that not all data information of the plurality of target programs is stored, target programs without data information, traversing the target programs without data information one by one to retrieve corresponding data information until data information of all the target programs is obtained, and collecting all the data information of the plurality of target programs.

6. The method of claim 5, wherein the traversing the target programs without data information one by one to retrieve the corresponding data information comprises:
sending a data calling request to each target program without data information, and determining whether data information fed back by the target programs without data information is received within a time length; and
determining, in response to determining that the data information fed back by the target program without data information is not received within the time length, a processing strategy according to a running status of the target program without data information, and performing control processing on the target program without data information according to the processing strategy; or
collecting, in response to determining that the data information fed back by the target program without data information is received within the time length, the fed back data information.

7. The method of claim 6, wherein the determining, in response to determining that the data information fed back by the target program without data information is not received within the time length, the processing strategy according to the running status of the target program without data information, and performing the control processing on the target program without data information according to the processing strategy comprises:
determining, in response to determining that the data information fed back by the target program without data information is not received within the time length, whether the running status of the target program without data information is a status of stopping running; and
ignoring, in response to determining that the running status of the target program without data information is the status of stopping running, target program with stopped running; or
sending, in response to determining that the running status of the target program without data information is a status of running, the data calling request again until data information fed back by the target program without data information is received, collecting the fed back data information, or, determining that the target program without data information is abnormal.

8. The method of claim 7, wherein the sending, in response to determining that the running status of the target program without data information is the status of running, the data calling request again until the data information fed back by the target program without data information is received, collecting the fed back data information, or, determining that the target program without data information is abnormal comprises:
sending, in response to determining that the running status of the target program without data information is the status of running, the data calling request again, and counting sending times of the data calling request; and
receiving, in response to determining that when the sending times is smaller than or equal to a times threshold, the data information fed back by the target program without data information, and collecting the fed back data information; or
determining, in response to determining that the sending times is greater than the times threshold and the data information fed back by the target program without data information is not received, that the target program without data information is abnormal, recording abnormal data, and ignoring the target program without data information.

9. The method of claim 6, wherein after collecting the fed back data information, the method further comprises:
determining whether corresponding data information of all the target programs in running is collected, if yes, stopping traversing, and if not, continuously traversing.

10. A rendering control method, comprising:
generating, in a debugging process for a target program, an information acquisition instruction for the target program by a rendering carrier, sending the information acquisition instruction to an operating terminal to collect data information of the target program by the operating terminal, and generating rendered data corresponding to the data information; and
receiving the rendered data from the operating terminal by the rendering carrier, and displaying the rendered data.

11. The method of claim 10, wherein before the generating the information acquisition instruction for the target program by the rendering carrier, the method further comprises:
sending an access request to the operating terminal by the rendering carrier, to generate a corresponding operation interface according to at least one program in running by the operating terminal;
receiving the operation interface fed back from the operating terminal by the rendering carrier, and displaying the operation interface in the rendering carrier; and
receiving the target program selected from the at least one program by the operation interface.

12. An electronic device, comprising;
a memory;
a processor; and
a computer program stored in the memory and capable of running in the processor,
wherein the processor, when performing the computer program, implements a rendering control method, and the method comprises:
receiving an information acquisition instruction for a target program sent from a client by a rendering carrier;
collecting data information of the target program according to the information acquisition instruction; and
generating rendered data according to the data information, and sending the rendered data to the rendering carrier of the client to display the rendered data in the rendering carrier.

13. The electronic device of claim 12, wherein before receiving the information acquisition instruction for the target program sent by the client using the rendering carrier, the method further comprises:
receiving an access request from the client using the rendering carrier;
determining, based on the access request, at least one program in running, and generating an operation interface containing the at least one program; and
sending the operation interface to the rendering carrier of the client to display the operation interface in the rendering carrier, and to determine the target program from the at least one program by the operation interface.

14. The electronic device of claim 12, wherein the collecting the data information of the target program according to the information acquisition instruction comprises:
determining a number of target programs according to the information acquisition instruction; and
determining an information collection manner according to the number of the target programs, and collecting data information of the target programs according to the information collection manner.

15. The electronic device of claim 14, wherein the determining the information collection manner according to the number of the target programs, and collecting the data information of the target programs according to the information collection manner comprises:
determining, in response to determining that a single target program is provided, whether a single piece of data information of the single target program is stored; and
collecting, in response to determining that the data information of the single target program is stored, the single piece of data information of the single target program; or
retrieving, in response to determining that the data information of the single target program is not stored, data information from the single target program, and collecting the data information of the single target program.

16. The electronic device of claim 14, wherein the determining the information collection manner according to the number of the target programs, and collecting data information of the target programs according to the information collection manner comprises:
determining, in response to determining that a plurality of target programs are provided, whether all data information of the plurality of target programs is stored; and
collecting, in response to determining that all the data information of the plurality of target programs is stored, all the data information of the plurality of target programs; or
determining, in response to determining that not all data information of the plurality of target programs is stored, target programs without data information, traversing the target programs without data information one by one to retrieve corresponding data information until data information of all the target programs is obtained, and collecting all the data information of the plurality of target programs.

17. The electronic device of claim 16, wherein the traversing the target programs without data information one by one to retrieve the corresponding data information comprises:
sending a data calling request to each target program without data information, and determining whether data information fed back by the target programs without data information is received within a time length; and
determining, in response to determining that the data information fed back by the target program without data information is not received within the time length, a processing strategy according to a running status of the target program without data information, and performing control processing on the target program without data information according to the processing strategy; or
collecting, in response to determining that the data information fed back by the target program without data information is received within the time length, the fed back data information.

18. The electronic device of claim 17, wherein the determining, in response to determining that the data information fed back by the target program without data information is not received within the time length, the processing strategy according to the running status of the target program without data information, and performing the control processing on the target program without data information according to the processing strategy comprises:
determining, in response to determining that the data information fed back by the target program without data information is not received within the time length, whether the running status of the target program without data information is a status of stopping running; and
ignoring, in response to determining that the running status of the target program without data information is the status of stopping running, target program with stopped running; or
sending, in response to determining that the running status of the target program without data information is a status of running, the data calling request again until data information fed back by the target program without data information is received, collecting the fed back data information, or, determining that the target program without data information is abnormal.

19. The electronic device of claim 18, wherein the sending, in response to determining that the running status of the target program without data information is the status of running, the data calling request again until the data information fed back by the target program without data information is received, collecting the fed back data information, or, determining that the target program without data information is abnormal comprises:
sending, in response to determining that the running status of the target program without data information is the status of running, the data calling request again, and counting sending times of the data calling request; and
receiving, in response to determining that when the sending times is smaller than or equal to a times threshold, the data information fed back by the target program without data information, and collecting the fed back data information; or
determining, in response to determining that the sending times is greater than the times threshold and the data information fed back by the target program without data information is not received, that the target program without data information is abnormal, recording abnormal data, and ignoring the target program without data information.

20. A non-transitory computer-readable storage medium storing computer instructions, wherein the computer instructions, when performed by a computer, are configured to perform the method of claim 1.
